(19) United States
(12) Patent Application Publication
(10) Pub. No.: US 2005/0227217 A1
(43) Pub. Date: Oct. 13, 2005

(54) Template matching on interactive surface

(76) Inventor: Andrew D. Wilson, Seattle, WA (US)

Correspondence Address: MICROSOFT CORPORATION;LAW OFFICES OF RONALD M. ANDERSON, 600 108TH AVENUE N.E., SUITE 507, BELLEVUE, WA, 98004, US

(21) Appl. No.: 10/813,855

(22) Filed: Mar. 31, 2004

(51) Int. Cl. G09B 7/00

(52) U.S. Cl. 434/337

(57) ABSTRACT

A patterned object that is placed on or adjacent to a display surface of an interactive display is detected by matching an image produced using infrared light reflected from the patterned object with one of a set of templates associated with the patterned object. The templates are created for each of a plurality of incremental rotations of the patterned object on a display surface. To implement the comparison, a sum of template data value corresponding to the intensities of the reflected light is calculated for the image of the patterned object and for each of the templates. These sums are compared to determine a rotated template that matches the patterned object within a predefined threshold, thus determining that the patterned object has been placed on or near the display surface.

### FIELD OF THE INVENTION

The present invention generally pertains to the use of templates for determining whether an object is present, and more specifically, pertains to the use of template matching to determine if a patterned object has been present on or near a surface through which the patterned object is detected using reflected infrared light.

### BACKGROUND OF THE INVENTION

Many barcode systems have been developed techniques for detecting binary code patterns. Some barcode systems use a vision system to acquire a multi-level input image, binarize the image, and then search for one or more binary codes in the binarized image. Also, some pattern recognition systems, such as fingerprint matching systems, use binary data for pattern matching. Although effective for certain applications, it is often desirable to also detect more complex patterns that comprise more than the two values of binary data. Thus, a number of template matching systems have been developed to detect a pattern with multiple intensity levels. For example, face-recognition systems can detect and identify a human face in an input image based on pixel intensity levels in previously stored template images of the human faces. Similarly, industrial vision systems are often employed to detect part defects or other characteristics of products relative to a template pattern.

Pattern recognition systems are generally good at detecting template patterns in controlled environments, but it is more difficult to select desired patterns from among random scenes or when the orientation of the desired pattern in an image is unknown. Typically, unique characteristics of a desired pattern are determined, and the unique characteristics are sought within a random scene. The unique characteristics help eliminate portions of an input image of the scene that are unlikely to include the desired pattern, and instead, focus on the portions of the input image that are most likely to include the desired pattern. However, using unique characteristics requires predetermining the unique characteristics and somehow informing a detection system to search for the unique characteristics in the input image.

Alternatively, differencing methods can be used to find areas of an input image that have the least difference from the desired pattern. However, differencing methods are computationally intensive, since they are typically performed on a pixel-by-pixel basis and require multiple iterations to account for multiple possible orientations. Thus, differencing methods alone are not conducive to real-time interactive systems, such as simulations that involve dynamic inputs, displays, and interactions with a user. A combination of unique characteristics and differencing methods can be used to narrow or reduce the areas of an input image that should be evaluated more carefully with a differencing method. Yet, the unique characteristics must still be predetermined and provided to the detection system.

It would therefore be desirable to detect a desired pattern without predetermining unique characteristics, while quickly locating those portions of a surface area in the image that are likely to include the desired pattern. Moreover, it would be desirable to detect the desired pattern for any orientation of a region within a surface area that can include a random set of patterns and/or objects, particularly in a surface area that is used for dynamic interaction with a user. The technique should be particularly useful in connection with an interactive display table to enable optical detection and identification of objects placed on a display surface of the table. While interactive displays are known in the art, it is not apparent that objects can be recognized by these prior art systems, other than by the use of identification tags with encoded binary data that are applied to the objects. If encoded tags or simple binary data defining an image or regions of contact are not used, the prior art fails to explain how objects can be recognized using more complex pattern matching to templates. Accordingly, it would clearly be desirable to provide a method and apparatus for accomplishing object recognition based on more complex data, by comparison of the data to templates.

There are several reasons why an acceptable method and apparatus for carrying out object recognition in this manner has not yet been developed. Until recently, it has been computationally prohibitive to implement object recognition of objects placed on a surface based upon optical shape processing in real time using commonly available hardware. An acceptable solution to this problem may require more efficient processing, such as the use of a Streaming SIMD (Single Instruction stream Multiple Data stream) Extensions 2 (SSE2) (vectorized) implementation. The accuracy of the results of a template matching process relies on the accuracy of the geometric and illumination normalization process when imaging an object's shape, which has not been fully addressed in the prior art. To provide an acceptable solution to this problem, it is likely also important to produce a template from the object in a live training process. A solution to this problem thus will require an appropriate combination of computer vision and computer-human interface technologies.

### SUMMARY OF THE INVENTION

A software application that is designed to be executed in connection with an interactive display table may require that one or more objects be recognized when the object(s) are placed on or adjacent to an interactive display surface of the interactive display table. For example, a patterned object might be a die, so that the pattern that is recognized includes the pattern of spots on one of the faces of the die. When the pattern of spots that is identified on the face of the die that is resting on the interactive display surface is thus determined, the face that is exposed on the top of the die is known, since opposite faces of a die have a defined relationship (i.e., the number of spots on the top face is equal to seven minus the number of spots on the bottom face). There are many other software applications in which it is important for the interactive display table to recognize a patterned object, and the pattern need not be associated with a specific value, but is associated with a specific object or one of a class of objects used in the software application.

To facilitate the recognition of patterned objects that are placed on the interactive display surface, the present invention employs template matching. A patterned object may include a binary pattern or a gray scale pattern or the pattern can be the shape of the object. The pattern object has a characteristic image that is formed by infrared light reflected from the pattern object when it is placed on the interactive display surface. Accordingly, one aspect of the present invention is directed to a method for detecting such an object.

The interactive display surface has a surface origin, and a plurality of surface coordinate locations defined along two orthogonal axes in relation to the surface origin. The method includes the steps of detecting a physical property of the patterned object when the patterned object is placed in any arbitrary orientation adjacent to an object side of the interactive display surface. A template of the patterned object is created at a known orientation and comprises a quadrilateral template bounding region having a side aligned with one of the two orthogonal axes and a set of template data values associated with the quadrilateral template bounding region. Each template data value represents a magnitude of the physical property at a different one of a plurality of surface coordinate locations within a bounding area encompassing the patterned object. A sum of the set of template data values is then computed. Input data values are then acquired from the interactive display surface, for example, after the patterned object is place on or adjacent thereto. Each of the input data values corresponds to a different one of the plurality of surface coordinate locations of the interactive display surface and represents a magnitude of the physical property detected at a different one of said plurality of surface coordinate locations. The method determines whether an integral sum of the input data values encompassed by the quadrilateral template bounding region is within a first threshold of the sum of the set of template data values, and if so, calculates a difference score between the template data values and the input data values encompassed by the quadrilateral template bounding region. If the difference score is within a match threshold, it is determined that the patterned object is on or adjacent to the interactive display surface.

The physical property that is detected preferably comprises light intensity, and more preferably, the intensity of infrared light reflected from the patterned object. Also, the template data values preferably comprise pixel values, each indicating an intensity of light reflected from the patterned object while the patterned object is adjacent to the interactive display surface in a template acquisition mode. Similarly, the input data values preferably comprise pixel values indicating an intensity of light reflected from the patterned object while the patterned object is on or adjacent to the interactive display surface in a run-time mode, when the software application in which the pattern object is to be detected is being executed.

The method further includes the step of creating a plurality of rotated templates, wherein each one of the plurality of rotated templates comprises a set of transformed template data values determined at a different rotation angle relative to the orthogonal axes. For each of the plurality of rotated templates, a binary mask is created. The binary mask includes an active region having a shape and encompassing the set of transformed template data values, and an orientation of the active region matches an orientation of the rotated template relative to the orthogonal axes. Also included is a mask bounding region that is used for the quadrilateral template bounding region. The mask bounding region has a quadrilateral shape, with a side aligned with one of the orthogonal axes, and surrounds the active region. An orientation of the mask bounding region remains fixed relative to the interactive display surface, and the dimensions of the mask bounding region are minimized to just encompass the active region. Using the mask bounding region as the quadrilateral template bounding region, a different rotated mask integral sum is computed for the input data values encompassed by each mask bounding region corresponding to each of the plurality of rotated templates. The rotated mask integral sum is evaluated relative to the first threshold. The method then determines for which of the plurality of rotated templates the rotated mask integral sum of the rotated template most closely matches the sum of the set of template data values encompassed by the corresponding mask bounding region.

In the method, a list of rotated templates that are within the first threshold is created. For each rotated template in the list, a distance between a first center associated with the mask bounding region corresponding to the rotated template and a second center associated with the mask bounding region used as the quadrilateral template bounding region is determined. The method also determines whether the distance is less than a redundancy threshold, and if so, replaces the rotated template in the list with the rotated template corresponding to the mask bounding region used as the quadrilateral template bounding region.

The step of determining the integral sum comprises the step of computing an integral image array from the input data values. The integral image array comprises a plurality of array elements, wherein each array element corresponds to one of the plurality of surface coordinate locations of the interactive display surface. Each array element also comprises a sum of all input data values encompassed by a quadrilateral area, from the surface origin to a corresponding surface coordinate location. Four array elements corresponding to four comers of the quadrilateral template bounding region are selected for association with a selected surface coordinate location and so as to align with the orthogonal axes. The integral sum is then computed as a function of the four array elements, each of which represents an area encompassing input data values of the interactive display surface. This step thus determines the sum of input data values encompassed by the quadrilateral template bounding region as a function of sums of quadrilateral areas between the surface origin and the quadrilateral template bounding region.

Also included in the method is the step of associating the quadrilateral template bounding region with a succession of surface coordinate locations to determine an integral sum that most closely matches the sum of the set of template data values in order to detect a region of the interactive display surface to which the patterned object is adjacent. A plurality of integral sums are determined for a plurality of mask bounding regions corresponding to a plurality of rotated templates at each of the succession of surface coordinate locations.

The difference score is calculated as either a sum of absolute differences or a sum of squared differences, although other difference computations can alternatively be employed. Also included are the steps of computing a statistical moment of the set of template data values, computing a statistical moment of the input data values, and determining whether the statistical moment of the input data values is within a moment threshold percentage of the statistical moment of the set of template data values.

Another aspect of the present invention is directed to a memory medium on which are stored machine instructions for carrying out the steps that are generally consistent with the method described above.

Still another aspect of the present invention is directed to a system for detecting a patterned object. The system includes an interactive display surface having a surface origin, a plurality of surface coordinate locations defined along two orthogonal axes in relation to the surface origin, an interactive side adjacent to which the patterned object can be placed and manipulated, and an opposite side. The system includes a light source that directs infrared light toward the opposite side of the interactive display surface and through the interactive display surface, to the interactive side, a light sensor disposed to receive and sense infrared light reflected back from the patterned object through the interactive display surface, a processor in communication with the light sensor, and a memory in communication with the processor. The memory stores data and machine instructions that cause the processor to carry out a plurality of functions. These functions are generally consistent with the steps of the method discussed above.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a functional block diagram of a generally conventional computing device or personal computer (PC) that is suitable for image processing for the interactive display table as used in practicing the present invention;

FIG. 2 is an illustration of the interior of the interactive display table showing hardware components included, and the paths followed by light within the interactive display table, and exemplary objects disposed on and above the surface of the interactive display table;

FIG. 3 is an isometric view of an interactive display table coupled to the PC externally;

FIG. 4 is a flow chart illustrating the logical steps employed in the present invention for acquiring a new template;

FIG. 5 is a flow chart illustrating the logical steps of the process for initializing template recognition;

FIG. 6 is a flow chart illustrating the logical steps for preparing templates for run-time of a software application in which the templates will be used for determining that a patterned object has been placed on or adjacent to a display surface of the interactive display table, and enabling the templates for use by the software application;

FIG. 7 is a high level flow chart showing the logical steps employed in recognizing a template for use in determining whether a patterned object has been placed on or adjacent to the display surface;

FIG. 8 is an overview flow chart illustrating the steps implemented in a search process to determine whether a recognizable patterned object is within the largest mask bounding region;

FIG. 9 is a flow chart showing the logical steps for checking rotated versions of the current enabled template against the input image of the reflected infrared light;

FIG. 10 is a flow chart illustrating the logical steps employed for computing a sum of absolute differences (SAD);

FIG. 11 is a flow chart showing the logical steps for computing a SAD match score between a rotated template and the image under the rotated template mask; and

FIG. 12 is a flow chart of the logical steps employed for testing the template hypotheses used in determining the best match between a template and a possible patterned object.

### DESCRIPTION OF THE PREFERRED EMBODIMENT

Exemplary Computing System for Implementing Present Invention

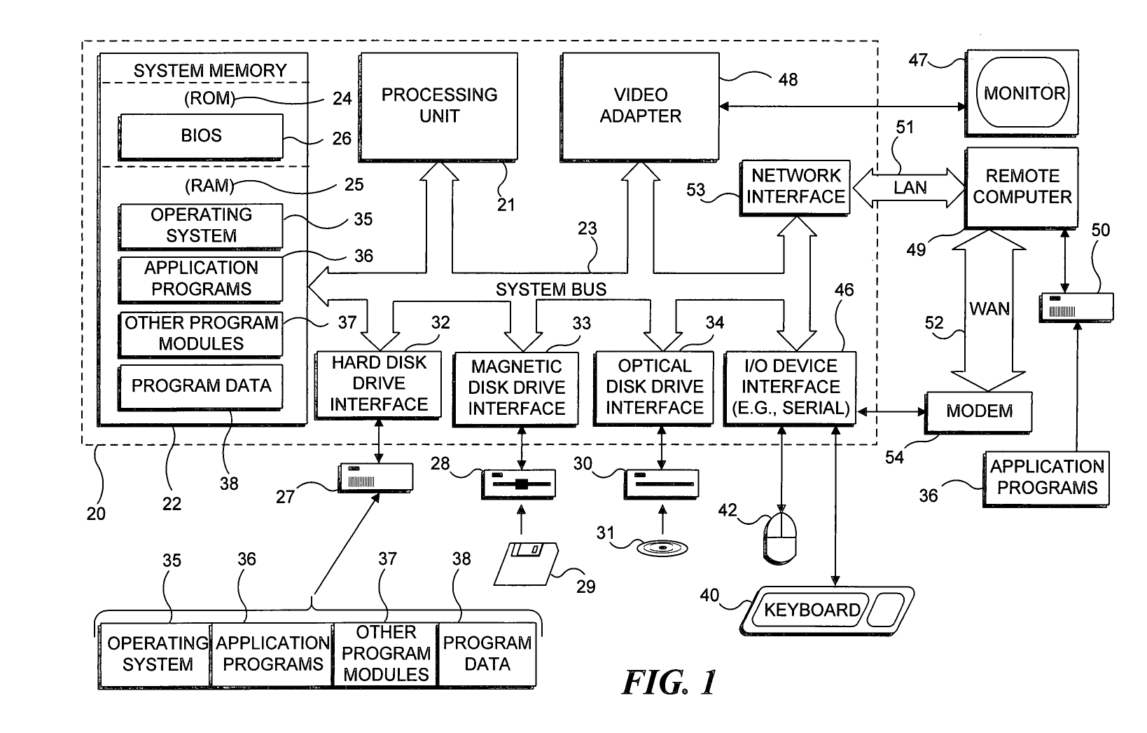

With reference to FIG. 1, an exemplary system suitable for implementing various portions of the present invention is shown. The system includes a general purpose computing device in the form of a conventional PC 20, provided with a processing unit 21, a system memory 22, and a system bus 23. The system bus couples various system components including the system memory to processing unit 21 and may be any of several types of bus structures, including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the PC 20, such as during start up, is stored in ROM 24. PC 20 further includes a hard disk drive 27 for reading from and writing to a hard disk (not shown), a magnetic disk drive 28 for reading from or writing to a removable magnetic disk 29, and an optical disk drive 30 for reading from or writing to a removable optical disk 31, such as a compact disk-read only memory (CD-ROM) or other optical media. Hard disk drive 27, magnetic disk drive 28, and optical disk drive 30 are connected to system bus 23 by a hard disk drive interface 32, a magnetic disk drive interface 33, and an optical disk drive interface 34, respectively. The drives and their associated computer readable media provide nonvolatile storage of computer readable machine instructions, data structures, program modules, and other data for PC 20. Although the exemplary environment described herein employs a hard disk, removable magnetic disk 29, and removable optical disk 31, it will be appreciated by those skilled in the art that other types of computer readable media, which can store data and machine instructions that are accessible by a computer, such as magnetic cassettes, flash memory cards, digital video disks (DVDs), Bernoulli cartridges, RAMs, ROMs, and the like, may also be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information in PC 20 and provide control input through input devices, such as a keyboard 40 and a pointing device 42. Pointing device 42 may include a mouse, stylus, wireless remote control, or other pointer, but in connection with the present invention, such conventional pointing devices may be omitted, since the user can employ the interactive display for input and control. As used hereinafter, the term “mouse” is intended to encompass virtually any pointing device that is useful for controlling the position of a cursor on the screen. Other input devices (not shown) may include a microphone, joystick, haptic joystick, yoke, foot pedals, game pad, satellite dish, scanner, or the like. These and other input/output (I/O) devices are often connected to processing unit 21 through an I/O interface 46 that is coupled to the system bus 23. The term I/O interface is intended to encompass each interface specifically used for a serial port, a parallel port, a game port, a keyboard port, and/or a universal serial bus (USB). System bus 23 is also connected to a camera interface 59, which is coupled to an interactive display 60 to receive signals form a digital video camera that is included therein, as discussed below. The digital video camera may be instead coupled to an appropriate serial I/O port, such as to a USB version 2.0 port. Optionally, a monitor 47 can be connected to system bus 23 via an appropriate interface, such as a video adapter 48; however, the interactive display of the present invention can provide a much richer display and interact with the user for input of information and control of software applications and is therefore preferably coupled to the video adaptor. It will be appreciated that PCs are often coupled to other peripheral output devices (not shown), such as speakers (through a sound card or other audio interface—not shown) and printers.

The present invention may be practiced on a single machine, although,PC 20 can also operate in a networked environment using logical connections to one or more remote computers, such as a remote computer 49. Remote computer 49 may be another PC, a server (which is typically generally configured much like PC 20), a router, a network PC, a peer device, or a satellite or other common network node, and typically includes many or all of the elements described above in connection with PC 20, although only an external memory storage device 50 has been illustrated in FIG. 1. The logical connections depicted in FIG. 1 include a local area network (LAN) 51 and a wide area network (WAN) 52. Such networking environments are common in offices, enterprise wide computer networks, intranets, and the Internet.

When used in a LAN networking environment, PC 20 is connected to LAN 51 through a network interface or adapter 53. When used in a WAN networking environment, PC 20 typically includes a modem 54, or other means such as a cable modem, Digital Subscriber Line (DSL) interface, or an Integrated Service Digital Network (ISDN) interface for establishing communications over WAN 52, such as the Internet. Modem 54, which may be internal or external, is connected to the system bus 23 or coupled to the bus via I/O device interface 46, i.e., through a serial port. In a networked environment, program modules, or portions thereof, used by PC 20 may be stored in the remote memory storage device. It will be appreciated that the network connections shown are exemplary and other means of establishing a communications link between the computers may be used, such as wireless communication and wide band network links.

Exemplary Interactive Surface

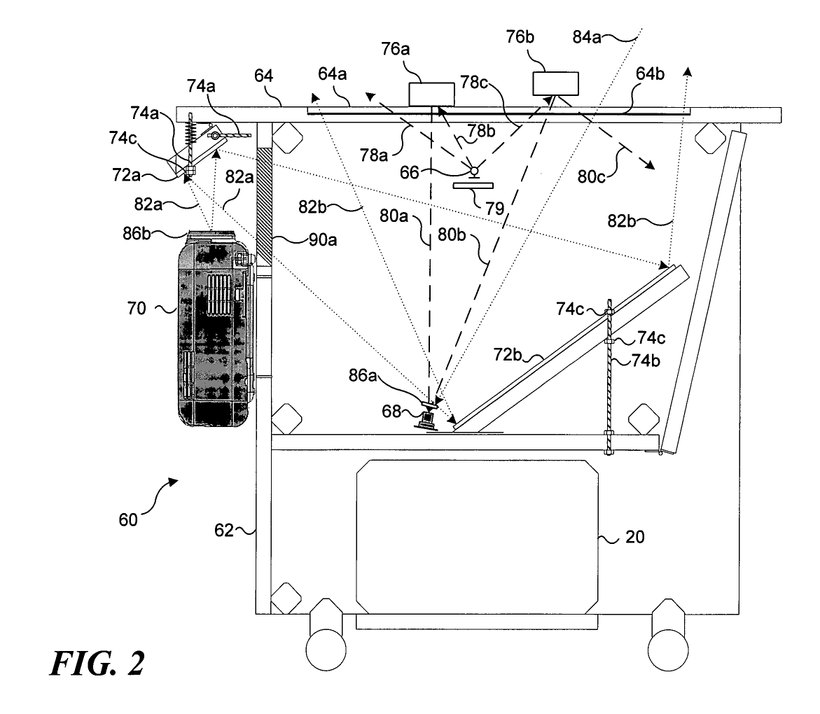

In FIG. 2, an exemplary interactive display table 60 is shown that includes PC 20 within a frame 62 and which serves as both an optical input and video display device for the computer. In this cut-away Figure of the interactive display table, rays of light used for displaying text and graphic images are generally illustrated using dotted lines, while rays of infrared (IR) light used for sensing objects on or just above a display surface 64a of the interactive display table are illustrated using dash lines. Display surface 64a is set within an upper surface 64 of the interactive display table. The perimeter of the table surface is useful for supporting a user's arms or other objects, including objects that may be used to interact with the graphic images or virtual environment being displayed on display surface 64a.

IR light sources 66 preferably comprise a plurality of IR light emitting diodes (LEDs) and are mounted on the interior side of frame 62. The IR light that is produced by IR light sources 66 is directed upwardly toward the underside of display surface 64a, as indicated by dash lines 78a, 78b, and 78c. The IR light from IR light sources 66 is reflected from any objects that are atop or proximate to the display surface after passing through a translucent layer 64b of the table, comprising a sheet of vellum or other suitable translucent material with light diffusing properties. Although only one IR source 66 is shown, it will be appreciated that a plurality of such IR sources may be mounted at spaced-apart locations around the interior sides of frame 62 to prove an even illumination of display surface 64a. The infrared light produced by the IR sources may:
exit through the table surface without illuminating any objects, as indicated by dash line 78a;
illuminate objects on the table surface, as indicated by dash line 78b; or
illuminate objects a short distance above the table surface but not touching the table surface, as indicated by dash line 78c.

Objects above display surface 64a include a “touch” object 76a that rests atop the display surface and a “hover” object 76b that is close to but not in actual contact with the display surface. As a result of using translucent layer 64b under the display surface to diffuse the IR light passing through the display surface, as an object approaches the top of display surface 64a, the amount of IR light that is reflected by the object increases to a maximum level that is achieved when the object is actually in contact with the display surface.

A digital video camera 68 is mounted to frame 62 below display surface 64a in a position appropriate to receive IR light that is reflected from any touch object or hover object disposed above display surface 64a. Digital video camera 68 is equipped with an IR pass filter 86a that transmits only IR light and blocks ambient visible light traveling through display surface 64a along dotted line 84a. A baffle 79 is disposed between IR source 66 and the digital video camera to prevent IR light that is directly emitted from the IR source from entering the digital video camera, since it is preferable that this digital video camera should produce an output signal that is only responsive to the IR light reflected from objects that are a short distance above or in contact with display surface 64a and corresponds to an image of IR light reflected from objects on or above the display surface. It will be apparent that digital video camera 68 will also respond to any IR light included in the ambient light that passes through display surface 64a from above and into the interior of the interactive display (e.g., ambient IR light that also travels along the path indicated by dotted line 84a).

IR light reflected from objects on or above the table surface may be:
reflected back through translucent layer 64b, through IR pass filter 86a and into the lens of digital video camera 68, as indicated by dash lines 80a and 80b; or
reflected or absorbed by other interior surfaces within the interactive display without entering the lens of digital video camera 68, as indicated by dash line 80c.

Translucent layer 64b diffuses both incident and reflected IR light. Thus, as explained above, “hover” objects that are closer to display surface 64a will reflect more IR light back to digital video camera 68 than objects of the same reflectivity that are farther away from the display surface. Digital video camera 68 senses the IR light reflected from “touch” and “hover” objects within its imaging field and produces a digital signal corresponding to images of the reflected IR light that is input to PC 20 for processing to determine a location of each such object, and optionally, the size, orientation, and shape of the object. It should be noted that a portion of an object (such as a user's forearm) may be above the table while another portion (such as the user's finger) is in contact with the display surface. In addition, an object may include an IR light reflective pattern or coded identifier (e.g., a bar code) on its bottom surface that is specific to that object or to a class of related objects of which that object is a member. Accordingly, the imaging signal from digital video camera 68 can also be used for detecting each such specific object, as well as determining its orientation, based on the IR light reflected from its reflective pattern, in accord with the present invention. The logical steps implemented to carry out this function are explained below.

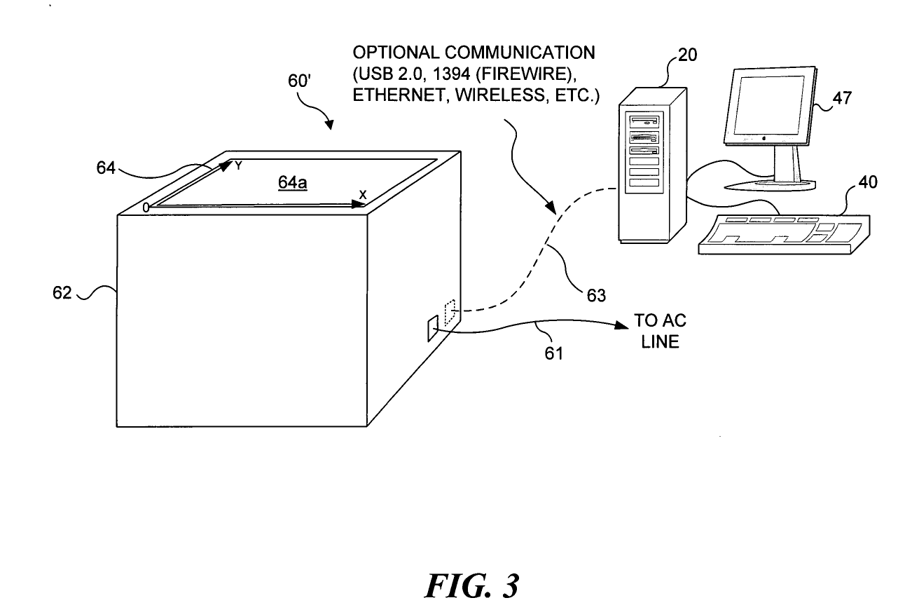

PC 20 may be integral to interactive display table 60 as shown in FIG. 2, or alternatively, may instead be external to the interactive display table, as shown in the embodiment of FIG. 3. In FIG. 3, an interactive display table 60′ is connected through a data cable 63 to an external PC 20 (which includes optional monitor 47, as mentioned above). As also shown in this Figure, a set of orthogonal X and Y axes are associated with display surface 64a, as well as an origin indicated by “0.” While not discretely shown, it will be appreciated that a plurality of coordinate locations along each orthogonal axis can be employed to specify any location on display surface 64a.

If the interactive display table is connected to an external PC 20 (as in FIG. 3) or to some other type of external computing device, such as a set top box, video game, laptop computer, or media computer (not shown), then the interactive display table comprises an input/output device. Power for the interactive display table is provided through a power lead 61, which is coupled to a conventional alternating current (AC) source (not shown). Data cable 63, which connects to interactive display table 60′, can be coupled to a USB 2.0 port, an Institute of Electrical and Electronics Engineers (IEEE) 1394 (or Firewire) port, or an Ethernet port on PC 20. It is also contemplated that as the speed of wireless connections continues to improve, the interactive display table might also be connected to a computing device such as PC 20 via such a high speed wireless connection, or via some other appropriate wired or wireless data communication link. Whether included internally as an integral part of the interactive display, or externally, PC 20 executes algorithms for processing the digital images from digital video camera 68 and executes software applications that are designed to use the more intuitive user interface functionality of interactive display table 60 to good advantage, as well as executing other software applications that are not specifically designed to make use of such functionality, but can still make good use of the input and output capability of the interactive display table.

An important and powerful feature of the interactive display table (i.e., of either embodiments discussed above) is its ability to display graphic images or a virtual environment for games or other software applications and to enable an interaction between the graphic image or virtual environment visible on display surface 64a and identify patterned objects that are resting atop the display surface, such as a patterned object 76a, or are hovering just above it, such as a patterned object 76b.

Again referring to FIG. 2, interactive display table 60 includes a video projector 70 that is used to display graphic images, a virtual environment, or text information on display surface 64a. The video projector is preferably of a liquid crystal display (LCD) or digital light processor (DLP) type, with a resolution of at least 640×480 pixels. An IR cut filter 86b is mounted in front of the projector lens of video projector 70 to prevent IR light emitted by the video projector from entering the interior of the interactive display table where the IR light might interfere with the IR light reflected from object(s) on or above display surface 64a. A first mirror assembly 72a directs projected light traveling from the projector lens along dotted path 82a through a transparent opening 90a in frame 62, so that the projected light is incident on a second mirror assembly 72b. Second mirror assembly 72b reflects the projected light onto translucent layer 64b, which is at the focal point of the projector lens, so that the projected image is visible and in focus on display surface 64a for viewing.

Alignment devices 74a and 74b are provided and include threaded rods and rotatable adjustment nuts 74c for adjusting the angles of the first and second mirror assemblies to ensure that the image projected onto the display surface is aligned with the display surface. In addition to directing the projected image in a desired direction, the use of these two mirror assemblies provides a longer path between projector 70 and translucent layer 64b to enable a longer focal length (and lower cost) projector lens to be used with the projector.

Template Acquisition

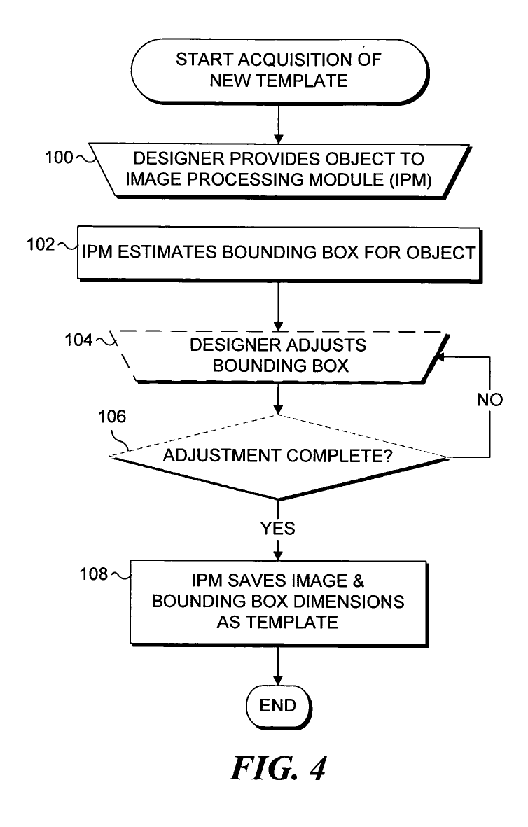

In FIG. 4, a flow diagram illustrates the process employed for acquiring a new template. Acquisition of new templates is accomplished prior to executing a software application in which it is necessary for the interactive display table to recognized patterned objects used in the software application when the patterned objects are placed on or adjacent to the display surface of the interactive display table. In a step 100, a designer of the software application places a patterned object on the interactive display table for image acquisition by an image processing module (IPM). The patterned object can be of any shape but has a unique pattern applied to it that is detectable based upon the image produced using the reflected infrared light from the patterned object.

In a step 102, the IPM estimates the size of a rectangular area large enough to surround the object. The IPM then displays a rectangular bounding box the size of the rectangular area around the object and aligned to the axes of the interactive display table. An optional step 104 enables the designer to interactively adjust the bounding box dimensions as desired. In an optional decision step 106, the IPM tests for a completion signal being input by the designer to indicate that the designer has finished adjusting the bounding box dimensions. If no completion signal is received, the process continues looping, returning to step 104 to enable the designer to continue adjusting the bounding box dimensions.

When a completion signal is received or if the optional steps 104 and 106 are not executed, the process continues at a step 108 in which the EPM saves the image contained within the bounding box and the dimension of the bounding box as a template. After the template is saved the acquisition process is completed.

Initializing Template Recognition

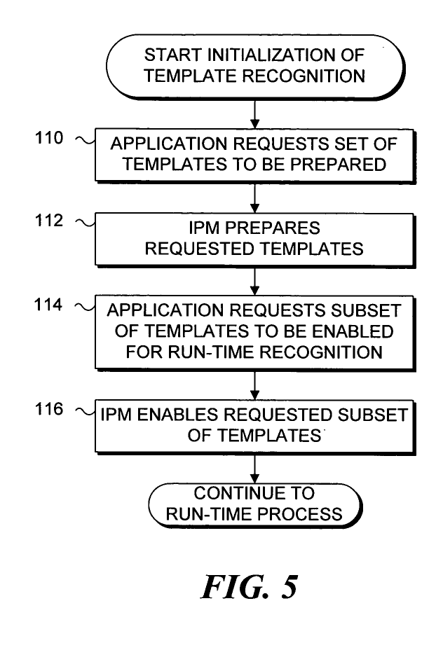

In FIG. 5, a flow diagram illustrates the logical steps of the process of initializing template recognition. The application must initialize the template(s) that will be used by a software application before attempting template matching. A step 110 provides for the software application to request the set of templates to be prepared that the application might use for matching against one or more patterned objects to determine that a specific pattern object has been placed on or adjacent to the display surface. The set of templates thus includes all of the templates that the software application might use while the software application is being run. Preparing all of the templates for use by a software application before they are required accelerates template access during the software application execution.

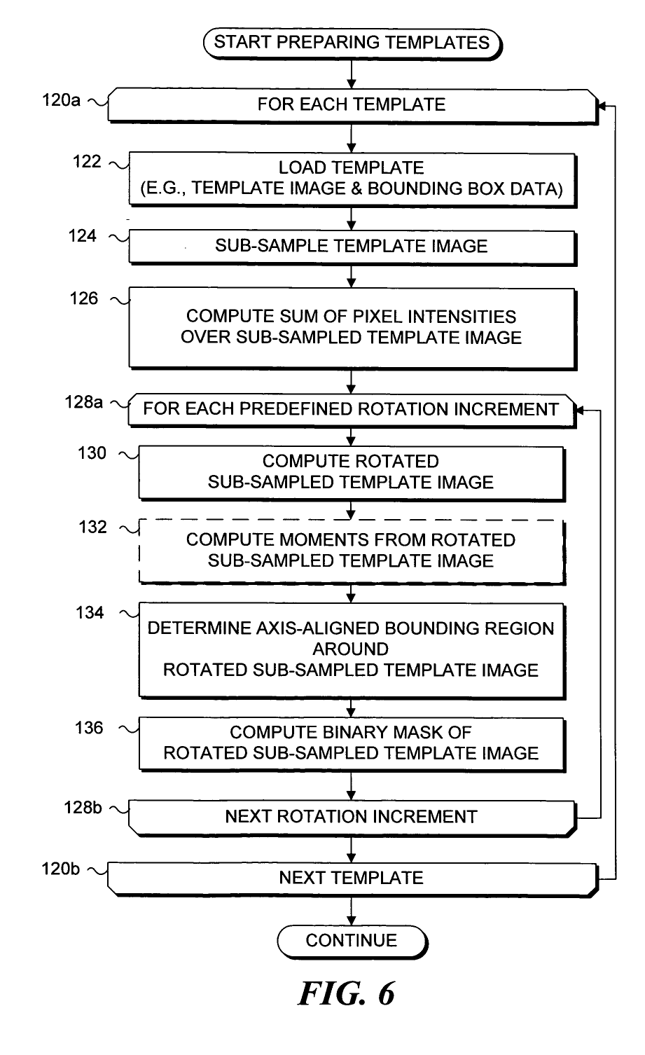

In a step 112, the IPM prepares the set of requested templates in response to the prepare request being received from the software application. The details of preparing each template in a set are discussed below with regard to FIG. 6. The process continues at a step 114, in which the software application requests a subset of the prepared templates to be “enabled” during execution of the software application. However, it will be appreciated that during execution of the software application, templates can be enabled or disabled, depending on the mode of the software application and other criteria specific to the application. The details of enabling a prepared template are also discussed below with regard to FIG. 6. In a step 116, the IPM enables the set of requested templates in response to the enable request being received from the software application. The step of enabling a prepared template includes the step of setting a flag to inform the software application that the template is to be used during the template matching process when a patterned object is placed on or adjacent to the display surface. After the templates are enabled, the template recognition initialization process is concluded.

Preparing Templates for Run-time

As indicated above, FIG. 6 illustrates the process for preparing templates for run-time, including enabling the templates. A step 120a begins an iterative process that successively prepares each template that the software application has requested. In a step 122, the IPM loads a requested template from storage (i.e., one of the template previously prepared, as discussed above). The template comprises the template image and the dimensions of the enclosing bounding box. A step 124 indicates that the IPM sub-samples the template image. Sub-sampling reduces the number of pixels the IPM will use in subsequent computations, thus accelerating performance during the template preparation process. In a step 126, the IPM computes a template intensity sum that is the sum of all the pixel intensities over the sub-sampled template image. A step 128a then provides that the IPM begins to iteratively rotate the template in predefined angular increments through a fall 360 degrees of template rotation, and perform calculations for each predefined increment through which the template image is rotated.

In a step 130, the IPM computes a rotated sub-sampled image. Optionally, in a step 132, the IPM computes moments, i.e., a mean and a covariance of the pixel intensities from the rotated sub-sampled template image to facilitate subsequent computations pertaining to the creation of a mask bounding region. In a step 134, the IPM calculates a mask bounding region that surrounds the rotated sub-sampled template image. This mask bounding region is not a true bounding box, which would be the smallest possible rectangle that can encompass the sub-sampled image, regardless of the rectangle's orientation. Instead, the mask bounding region is a rectangle that maintains a fixed orientation relative to the X and Y axes of the input sub-sampled image (i.e., its sides are aligned substantially parallel with the orthogonal axes (see FIG. 3) of the display surface). However, the two dimensions of the mask bounding region can grow and shrink as the sub-sampled image image is rotated. Thus, typically, the mask bounding region has different dimensions for each rotated sub-sampled template image.

In a step 136, the IPM computes a binary mask of the rotated sub-sampled template image. The binary mask comprises the mask bounding region (e.g., a rectangle) that encompasses a true bounding box (e.g., another rectangle) that is closely fit around an outline of the rotated sub-sampled image. Further, the binary mask is simply an array M(x,y), in which a pixel at (x,y) has the binary value “1” if the pixel belongs to the rotated template or the binary value “0” if the pixel falls in the adjacent region created when the original rectangular template is rotated. A step 128b advances to the next rotational increment for the current image template and returns to step 128a to repeat the process until the current image template has been rotated through 360 degrees. The next image templates is processed in a step 120b, returning to step 120a to repeat the processing for the next image template, until all image templates have been prepared. After all image templates are prepared, this portion of the logic is completed.

Run-time Template Recognition

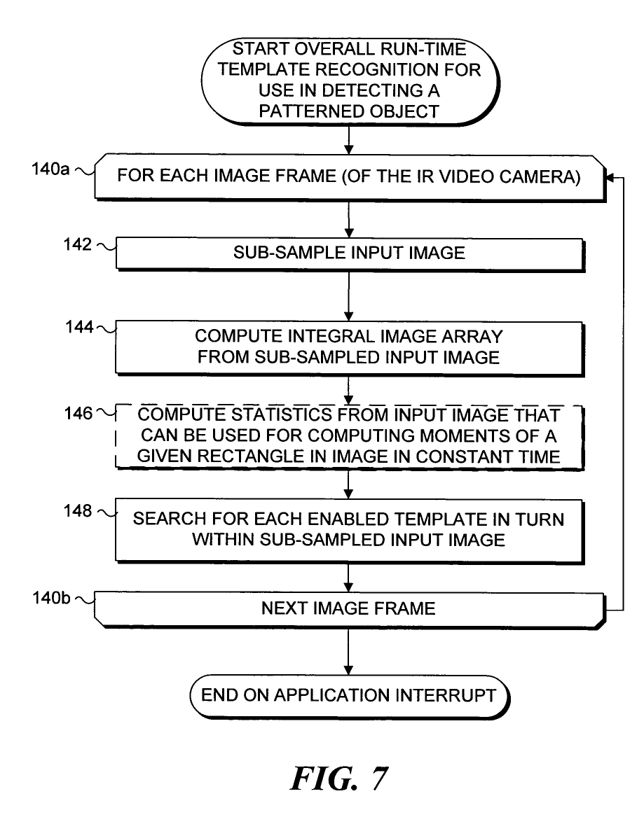

When the templates have been prepared for matching, the IPM can begin run-time template recognition. In FIG. 7, a flow diagram illustrates the overall process for recognizing a template usable to determine whether a patterned object has been placed on or adjacent to the display surface. In a step 140a, the IPM begins to iteratively process each video image frame produced by the infrared video camera, which captures infrared images of the patterned objects placed on or near the display surface at some predefined rate, e.g., from 15 to 60 frames per second. In a step 142, the IPM sub-samples the input image of reflected infrared light using the same algorithm employed for sub-sampling the template, as described above. Again, sub-sampling reduces the number of pixels the IPM will use in subsequent computations, thus accelerating performance.

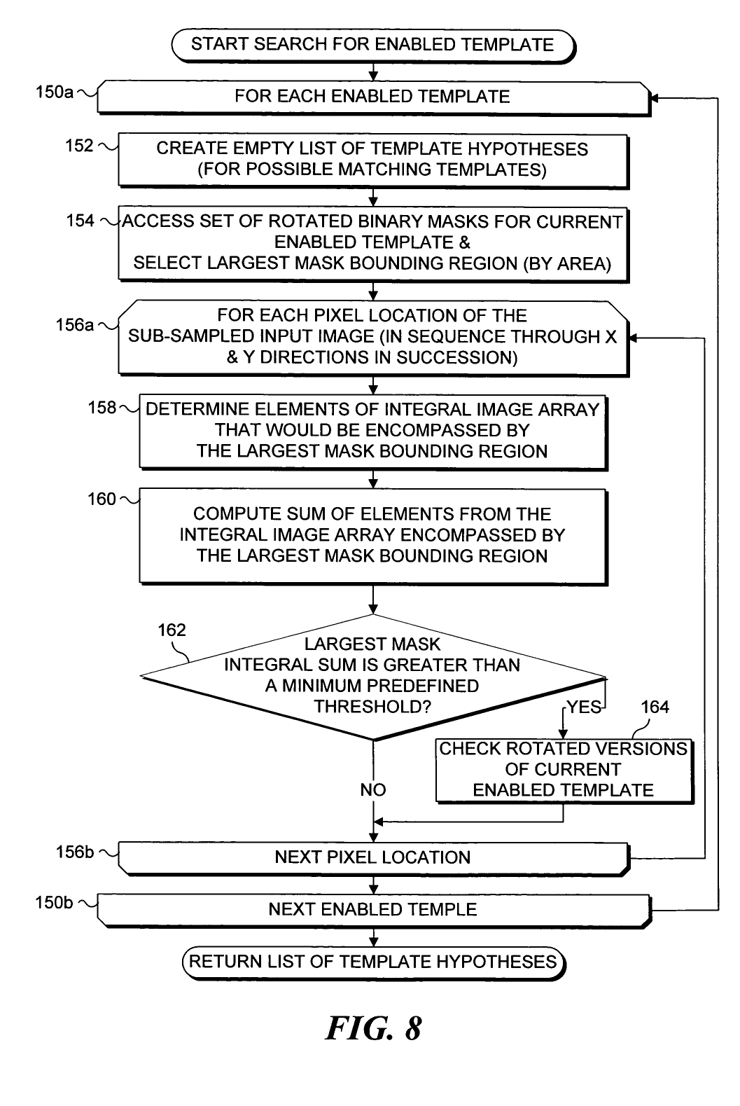

Next, in a step 144, the IPM computes an array of sums of pixel values for each pixel location from the upper left origin of the image frame through the current pixel location in the image frame. This approach for determining arrays of sums of pixel values is generally known in the prior art, as indicated by section 2.1 of a paper entitled, “Robust Real-time Object Detection,” by Paul Viola and Michael J. Jones, February 2001. Each x, y position or “pixel” of an integral “image” (i.e., each element of the array) represents the sum of all pixel values of the sub-sampled input image from the origin to the current “pixel” location in the image frame. In an optional step 146, during the pass over the input image, statistics are computed from the input image for subsequent use in computing moments of a given rectangle in the image in constant time. A step 148 provides that the IPM searches for each enabled template within the sub-sampled input image. The details of searching for each enabled template are discussed below, with regard to FIG. 8 through FIG. 12. The image frame iterations continue at a step 140b until the software application interrupts the template recognition process, since this process should generally continue, to detect each patterned object placed on or near the display surface while the software application is being executed.

Enabled Template Search

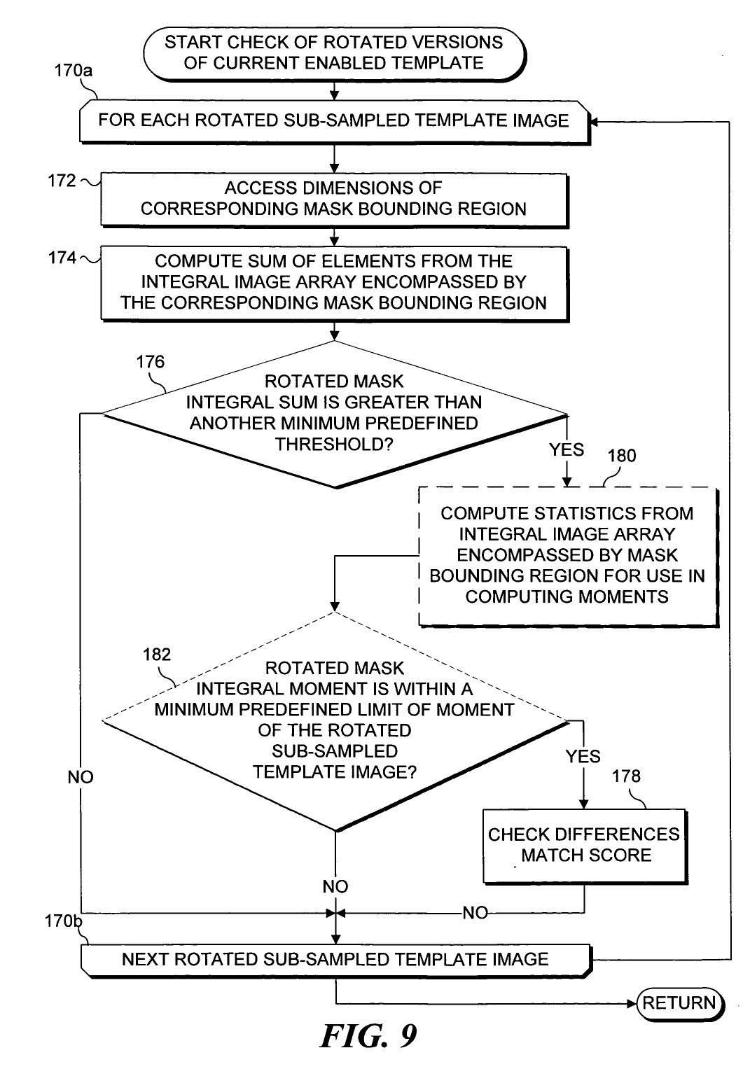

In FIG. 8, a flow diagram provides an overview of the complete search process used to determine whether a recognizable patterned object is within the largest mask bounding region. If so, the logic determines that a detailed check against each rotated template should be made. The details of detailed checking are discussed below with regard to FIG. 9.

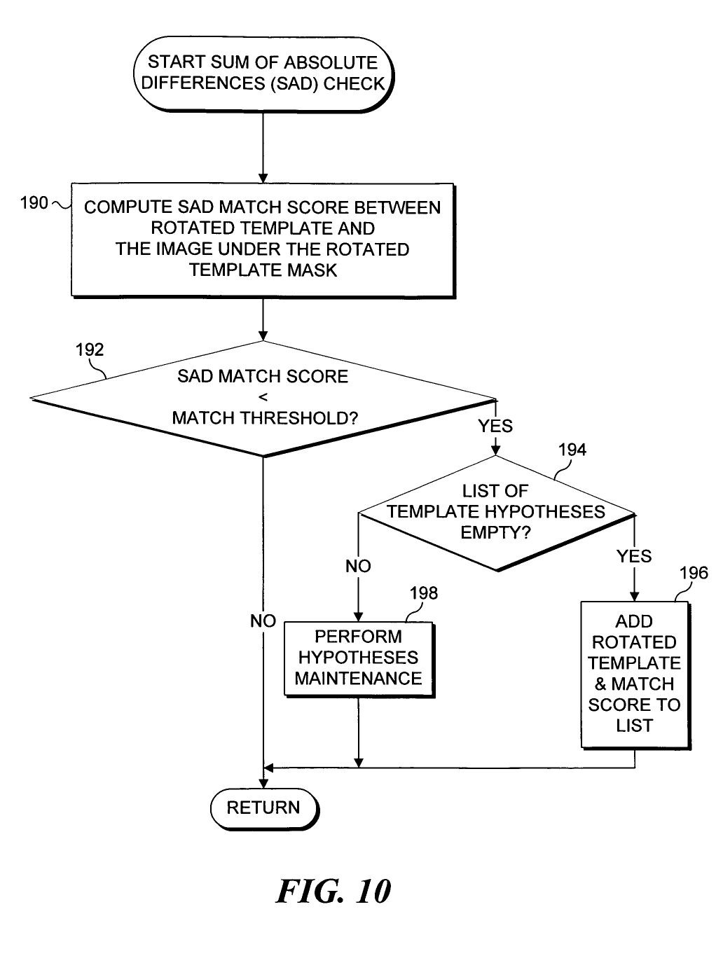

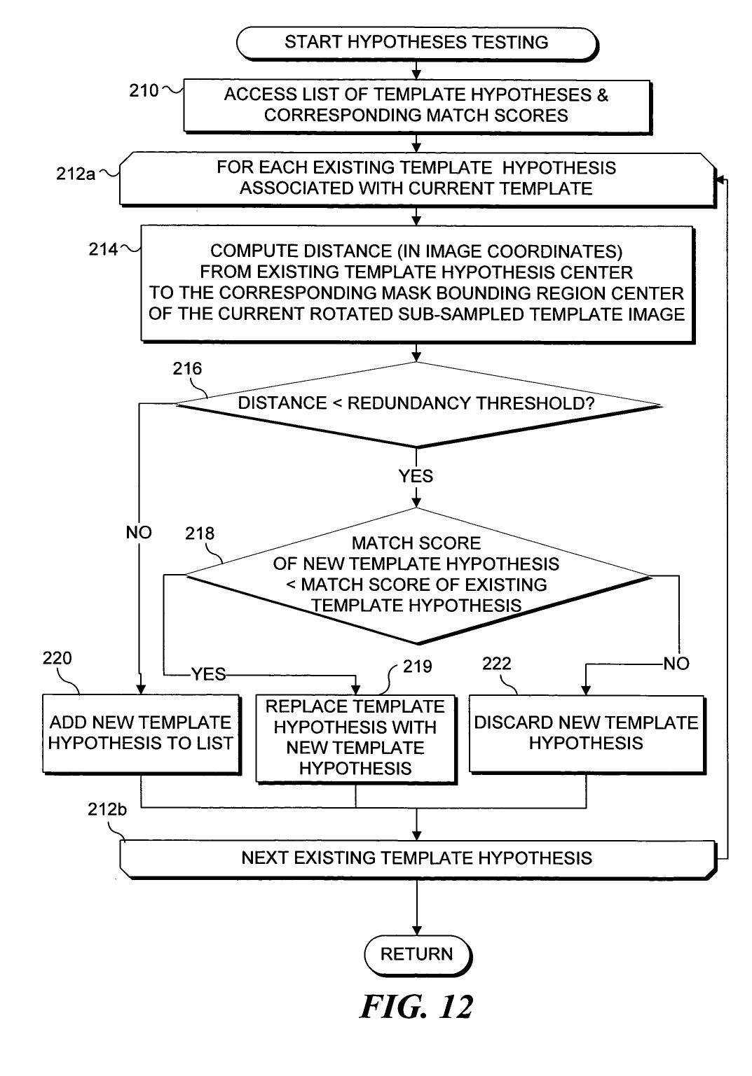

In a step 150a of FIG. 8, the IPM begins to iteratively process each enabled template. A step 152 indicates that the IPM creates an empty list of template hypotheses for possible matching templates, i.e., templates that might represent a good match to the patterned object in the orientation in which it is placed on or adjacent to the display surface. A list of hypotheses enables selecting a template that most closely matches the patterned object in the input image provided by the infrared video camera. Depending on the distance threshold set, it is possible that multiple instances of the object can be detected on the table (if a lower threshold is used), or if the threshold is set higher, only the best match of the object will be noted. This choice is best made in light of constraints of a software application in which object recognition is being used. Variants of this approach may be made by changing the set of template matches that are compared during one of the maintenance cycles. For example, it is possible to compare matches over multiple enabled related template types, so that the process discards all matches to one of the related templates if the object corresponding to the other related template is on the display surface. Similarly, multiple rotations of a template can match an object on the display surface (so that multiple rotations of the template are returned), or alternatively, only the best one can be chosen. The IPM will update the list of hypotheses, as discussed below with regard to FIG. 10 and FIG. 12.

In a step 154, the IPM accesses the set of rotated binary masks for the current enabled template and selects the largest mask bounding region by area. The largest mask bounding region is the largest fixed-orientation bounding region of the set of binary masks. The IPM begins to iteratively process areas of the input image in a step 156a, the processed area being the size of the largest mask bounding region. This process iterates through successive pixels, beginning with the pixel at the upper left corner of the area and proceeding pixel by pixel along each successive row of pixels in the “x” direction and then proceeding down one pixel in the “y” direction to process the next row of pixels, pixel by pixel, within the area being processed.

In a step 158, the IPM determines which elements of the integral image array are contained within the largest mask bounding region. A step 160 provides that the IPM computes the largest mask integral sum, which is the sum of the elements (i.e., pixels) from the integral image array that is encompassed by the largest mask bounding region. The largest mask integral sum is calculated using the integral sum computation described in the above-reference section 2.1 of the Viola and Jones paper, with regard to FIG. 3 of that paper. A decision step 162 determines if the largest mask integral sum is greater than a minimum predefined threshold. This threshold is preferably a predefined minimum percentage (typically 50% to 90% and more preferably 90%) of the template intensity sum computed in the process discussed above in connection with FIG. 6. If the largest mask integral sum is not greater than the predefined minimum percentage, the process proceeds to a step 156b, continuing with the pixel by pixel iteration.

If the largest mask integral sum is greater than the minimum percentage, then the process continues at a step 164 in which the IPM checks rotated versions of the current enabled template against the input image provided by the infrared video camera. The details of the steps for checking rotated versions of the current enabled template against the input image are discussed below with regard to FIG. 9. The process then proceeds to step 156b to continue the pixel by pixel location iteration. When the IPM completes the pixel by pixel location iteration, the IPM process continues to a step 150b to iteratively process the next enabled template. When the IPM completes the iterative searching for and processing each enabled template, the process returns the list of template hypotheses and terminates. The details employed for generating and testing the list of template hypotheses are discussed below with regard to FIG. 10 and FIG. 12.

Checking Rotated Versions of Currently Enabled Template

Having found a template with a largest mask integral sum greater than a predefined threshold, the IPM searches through the rotated versions of the template to determine which rotated version most closely matches the input image of infrared light reflected from a possible patterned object, provided by the infrared video camera. In FIG. 9, a flow diagram illustrates the process for checking rotated versions of the currently enabled template against the input image. The IPM only executes this process in FIG. 9 when a largest mask integral sum is greater than a predefined threshold, as noted above with regard to FIG. 8.

In a step 170a, the IPM begins to iteratively process each rotated sub-sampled template in succession. The IPM accesses the dimensions of the fixed orientation mask bounding region for the current rotated sub-sampled template image that was determined in FIG. 6, in a step 172. In a step 174, the IPM computes a rotated mask integral sum that is the sum of elements (pixels) from the integral image array encompassed by the corresponding mask bounding region. Note that the largest mask integral sum was previously calculated and need not be recalculated.

A decision step 176 provides that the IPM determines if the rotated mask integral sum is greater than another minimum predefined threshold. This threshold is greater than the threshold used in FIG. 8 and is also preferably a predefined minimum percentage (typically 80% to 95% and more preferably 95%) of the template intensity sum computed in FIG. 6. If the rotated mask integral sum is not greater than this other predefined threshold, the process proceeds to a step 170b to continue the iteration through the next of the rotated sub-sampled template images, until all have been processed. If the rotated mask integral sum is greater than the predefined threshold, the process continues at a step 178, where the IPM computes and checks the differences match score between a rotated template and the corresponding region of the image provided by the infrared video camera, where a lower differences match score indicates a better fit. The differences can be computed by finding the sum of absolute differences, the sum of squared differences, or by using any other suitable computation known to those of ordinary skill in this art. For example, it would alternatively be possible to employ edge-maps computed on the templates (ahead of time) and the input image (computed for every new input frame). This approach has the advantage that it is immune to changes in color or brightness of the object, to a certain extent. However, edge maps will behave somewhat differently than the current technique that is used in a preferred form of the invention. The details of computing a sum of absolute differences (SAD) are discussed below with regard to FIG. 10. After checking the differences match score, the process proceeds to step 170b to continue the iteration through the next rotated sub-sampled template image, until all have been processed.

Alternatively if the rotated mask integral sum is greater than the predefined threshold, the process can continue at an optional step 180 in which the IPM computes the rotated mask integral moment(s) (i.e., mean and covariance of the pixel intensities) which is(are) the moment(s) of the integral image array encompassed by the corresponding mask bounding region. The process then continues at an optional decision step 182 in which the IPM tests the rotated mask integral moment(s) for a minimum predefined similarity to the moment(s) of the rotated sub-sampled template image, e.g., to determine if they are within 20% of each other, in a preferred embodiment. If the moments are sufficiently similar, the process continues at step 178 in which the IPM computes and checks the differences match score between a rotated template and the image under the rotated template as described above. If the moments are too dissimilar (i.e., not less than a predefined limit), the process proceeds with step 170b to continue the iteration through the next rotated sub-sampled template image, until completed. The process for checking rotated versions of the currently enabled template against the input image is thus concluded when all rotated sub-sampled template images have been checked.

Sum of Absolute Differences (SAD) Check

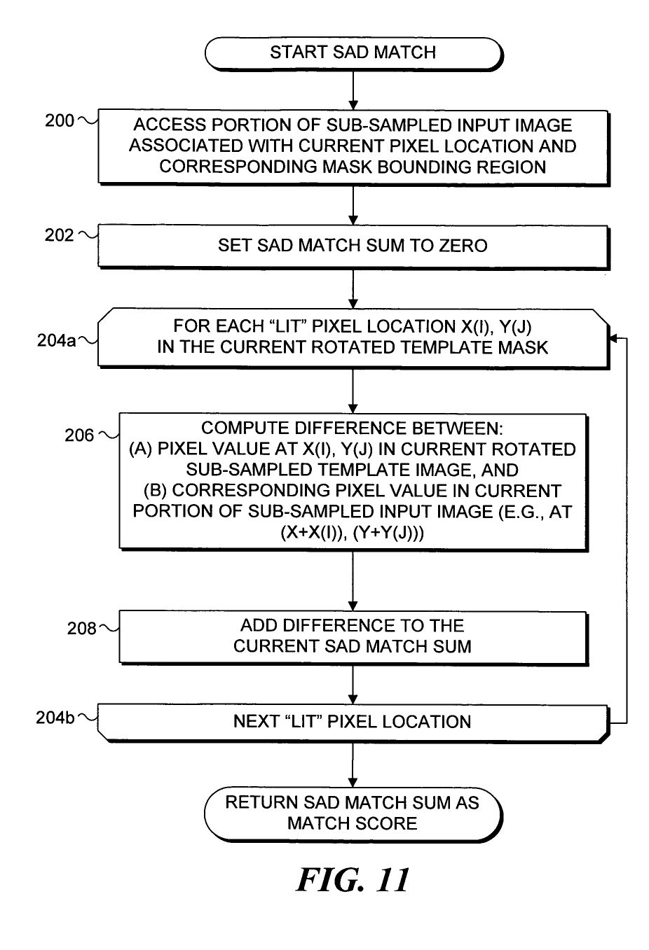

In FIG. 10 a flow diagram illustrates an overview of the SAD check. In a step 190, the IPM computes the SAD match score between a rotated template and the image under the rotated template mask. Calculating numeric differences between images provides values upon which decisions can be based. Details for computing the SAD match score between a rotated template and the image under the rotated template mask are discussed below with regard to FIG. 11.

In FIG. 10, a decision step 192 tests the SAD match score against a predefined match threshold. If the SAD match score is less than the match threshold (i.e., the rotated template and the image under the rotated template mask are sufficiently similar), then the process continues at a decision step 194, otherwise the process terminates. In decision step 194, the IPM examines the list of template hypotheses. If the list is empty, the process continues at a step 196 in which the IPM adds the rotated template and match score to the list. If the list is not empty, the process continues at a step 198 in which the IPM performs hypotheses testing. The details of hypotheses testing are discussed below with regard to FIG. 12.

SAD Match

In FIG. 11 a flow diagram illustrates, in an exemplary manner, the process for creating a SAD match. The IPM can readily implement SAD using Intel SSE2 instructions or another suitable difference computation.

With reference to a step 200 in FIG. 11, the IPM accesses a portion of the sub-sampled input image associated with the current pixel location and corresponding mask bounding region. The inner loop of FIG. 8 steps through the sub-sampled input image one pixel at a time using the largest mask bounding region. Here the IPM uses the mask bounding region that corresponds to the current rotated version of the template image. In most cases, this step will access a smaller region of the sub-sampled input region than the largest mask bounding region.

In a step 202 of FIG. 11, the IPM initializes the SAD match sum to zero and in a step 204a, begins to iteratively examine and process each pixel location x, y in the current rotated sub-sampled template mask where the binary value is equal to one. A step 206 indicates that the IPM computes the difference between: (1) the pixel value at (x,y) in the current rotated sub-sampled template image, and (2) the corresponding pixel value in the current portion of the sub-sampled input image (e.g., at (x₀+x), (y₀+y), where x₀ and y₀ are offsets from the origin of the input image along the orthogonal axes of the display surface). This step calculates the pixel intensity difference between the rotated template and the current portion of the input image to determine if the rotated template image closely matches the input image, i.e., within the limit that is predefined.

A step 208 provides that the EPM adds the difference calculated in step 206 to the current SAD match sum. Thus, a resulting cumulative sum reflects how closely the current portion of the input image matches the current rotated template image. A relatively small SAD match sum means there is very little difference between the portion of the input image and the rotated template image, and thus a close match of the images. Since the rotated template images are only determined for predefined increments of rotation, e.g., at 10 degree increments, it will be evident that a SAD match sum may exist simply because the patterned object is at a slightly different angular orientation than the closest matching rotated template image.

The process proceeds to a step 204b to continue the iteration through each pixel location (x,y) in the current rotated sub-sampled template mask that is equal to one. When differences for all such pixels in the current rotated sub-sampled template mask have been calculated and summed, the process terminates and returns the SAD match sum as the match score for that that rotated sub-sampled template mask.

Hypotheses Testing

In FIG. 12, a flow diagram illustrates the process for testing the template hypotheses. A list of hypotheses enables selecting a template that most closely matches a patterned object in the input image produced by the infrared video camera. In a step 210, the IPM accesses the list of template hypotheses and corresponding match scores. In a step 212a, the IPM iteratively compares each existing template hypothesis associated with the current rotated sub-sampled template until all in the list of template hypotheses have been tested. An existing template hypothesis is a template that was previously determined to have a match score within the match threshold and is thus included in the list. The current rotated sub-sampled template image may be referred to as the “new” template hypothesis in the following discussion.

In a step 214, the IPM computes the distance (in image coordinates that are based on the coordinates along the orthogonal axes of the display surface) from the existing template hypothesis center to the corresponding mask bounding region center of the new template hypothesis. In a decision step 216, the IPM compares the distance computed in step 214 to a predefined redundancy threshold. Preferably, the redundancy threshold indicates whether the two hypotheses (i.e., the current and the new) are within 20% of each other. If so, the hypotheses are considered redundant. If the distance is not less than the redundancy threshold, then the process continues at a step 220, in which the IPM adds the new template hypothesis to the list of hypotheses.

If the distance is less than the redundancy threshold, the process proceeds to a decision step 218 in which the IPM tests the match scores of the new template hypothesis and the existing template hypothesis. If the match score of the new template hypothesis is less than the match score of the existing template hypothesis, then the process continues at a step 219, in which the IPM replaces the existing (old) template hypothesis with the new template hypothesis on the list. Thereafter, the process continues at a step 212b in which the IPM continues to iteratively compare each existing template hypothesis associated with the current rotated sub-sampled template. If the match score of the new template hypothesis is not less than the match score of the existing template hypothesis, the process continues at step 222, where the new template hypothesis is discarded. Thereafter, the process proceeds to a step 212b, in which the IPM continues the process explained above for the next existing template hypothesis. When all existing template hypotheses associated with the current rotated sub-sampled template have been compared, the process is concluded.

It should be emphasized that the image formed of the patterned object is not limited to only black and white pixel values, but instead, can include a range of intensities at pixels within the image of the patterned object. The patterning can include various gray scale patterns, as well as different binary patterns. Also, as noted above, edge-maps can be computed on the templates (ahead of time) and the input image can be computed for every new input frame.

Although the present invention has been described in connection with the preferred form of practicing it and modifications thereto, those of ordinary skill in the art will understand that many other modifications can be made to this invention within the scope of the claims that follow. Accordingly, it is not intended that the scope of the invention in any way be limited by the above description, but instead be determined entirely by reference to the claims that follow.

1. A method for detecting a patterned object placed adjacent to an interactive display surface, the interactive display surface having a surface origin, and a plurality of surface coordinate locations defined along two orthogonal axes in relation to the surface origin, comprising the steps of:
(a) detecting a physical property of the patterned object when the patterned object is placed in any arbitrary orientation adjacent to an object side of an interactive display surface;
(b) creating a template of the patterned object at a known orientation, the template comprising a quadrilateral template bounding region having a side aligned with one of the two orthogonal axes and a set of template data values associated with the quadrilateral template bounding region, each template data value representing a magnitude of the physical property at a different one of a plurality of surface coordinate locations within a bounding area encompassing the patterned object;
(c) computing a sum of the set of template data values;
(d) acquiring input data values from the interactive display surface, each of the input data values corresponding to a different one of the plurality of surface coordinate locations of the interactive display surface, each input data value representing a magnitude of the physical property detected at a different one of said plurality of surface coordinate locations;
(e) calculating a difference score between the template data values and the input data values encompassed by the quadrilateral template bounding region; and
(f) if the difference score is within a match threshold, determining that the patterned object is on or adjacent to the interactive display surface.

2. The method of claim 1, further comprising the step of determining whether an integral sum of the input data values encompassed by the quadrilateral template bounding region is within a first threshold of the sum of the set of template data values, and if so, proceeding with the step of calculating the difference score.

3. The method of claim 1, wherein:
(a) the physical property that is detected comprises light intensity;
(b) the template data values comprise pixel values, each pixel value indicating an intensity of light reflected from the patterned object while the patterned object is adjacent to the interactive display surface in a template acquisition mode; and
(c) the input data values comprise pixel values indicating an intensity of light reflected from the patterned object while the patterned object is adjacent to the interactive display surface in a run-time mode.

4. The method of claim 2, further comprising the steps of:
(a) creating a plurality of rotated templates, wherein each one of the plurality of rotated templates comprises a set of transformed template data values determined at a different rotation angle relative to the orthogonal axes;
(b) for each of the plurality of rotated templates, creating a binary mask comprising:
(i) an active region having a shape and encompassing the set of transformed template data values, wherein an orientation of the active region matches an orientation of the rotated template relative to the orthogonal axes; and
(ii) a mask bounding region that is used for the quadrilateral template bounding region, the mask bounding region having a quadrilateral shape with a side aligned with one of the orthogonal axes and surrounding the active region, wherein an orientation of the mask bounding region remains fixed relative to the interactive display surface, and wherein dimensions of the mask bounding region are minimized to just encompass the active region;
(c) performing the step of claim 2 using the mask bounding region as the quadrilateral template bounding region so that a different rotated mask integral sum is computed for the input data values encompassed by each mask bounding region corresponding to each of the plurality of rotated templates, and so that the rotated mask integral sum is evaluated relative to the first threshold; and
(d) determining for which of the plurality of rotated templates the rotated mask integral sum of the rotated template most closely matches the sum of the set of template data values encompassed by the corresponding mask bounding region.

5. The method of claim 4, wherein step (d) of claim 3 comprises the steps of:
(a) creating a list of rotated templates that are within the first threshold; and
(b) for each rotated template in the list, determining a distance between a first center associated with the mask bounding region corresponding to the rotated template and a second center associated with the mask bounding region used as the quadrilateral template bounding region;
(c) determining whether the distance is less than a redundancy threshold; and
(d) if the distance is less than the redundancy threshold, replacing the rotated template in the list with the rotated template corresponding to the mask bounding region used as the quadrilateral template bounding region.

6. The method of claim 2, wherein the step of determining the integral sum comprises the steps of:
(a) computing an integral image array from the input data values, the integral image array comprising a plurality of array elements, each array element corresponding to one of the plurality of surface coordinate locations of the interactive display surface, and each array element comprising a sum of all input data values encompassed by a quadrilateral area from the surface origin to a corresponding surface coordinate location;
(b) selecting four array elements corresponding to four corners of the quadrilateral template bounding region, for association with a selected surface coordinate location and to align with the orthogonal axes; and
(c) computing the integral sum as a function of the four array elements, each of which represents an area encompassing input data values of the interactive display surface, thereby determining the sum of input data values encompassed by the quadrilateral template bounding region as a function of sums of quadrilateral areas between the surface origin and the quadrilateral template bounding region.

7. The method of claim 6, further comprising the step of associating the quadrilateral template bounding region with a succession of surface coordinate locations to determine an integral sum most closely matching the sum of the set of template data values, to detect a region of the interactive display surface to which the patterned object is adjacent.

8. The method of claim 7, wherein a plurality of integral sums are determined for a plurality of mask bounding regions corresponding to a plurality of rotated templates at each of the succession of surface coordinate locations.

9. The method of claim 1, wherein the difference score is calculated as one of a sum of absolute differences and a sum of squared differences.

10. The method of claim 1, further comprising the steps of:
(a) computing a statistical moment of the set of template data values;
(b) computing a statistical moment of the input data values; and
(c) determining whether the statistical moment of the input data values is within a moment threshold percentage of the statistical moment of the set of template data values.

11. A memory medium on which are stored machine instructions for carrying out the steps of claim 1.

12. A system for detecting a patterned object, comprising:
(a) an interactive display surface having a surface origin, a plurality of surface coordinate locations defined along two orthogonal axes in relation to the surface origin, an interactive side adjacent to which the patterned object can be placed and manipulated, and an opposite side;
(b) a light source that directs infrared light toward the opposite side of the interactive display surface and through the interactive display surface, to the interactive side;
(c) a light sensor disposed to receive and sense infrared light reflected back from the patterned object through the interactive display surface;
(d) a processor in communication with the light sensor; and
(e) a memory in communication with the processor, the memory storing data and machine instructions that cause the processor to carry out a plurality of functions, including:
(i) detecting an intensity of the infrared light reflected back from the patterned object with the light sensor;
(ii) creating a template of the patterned object at a known orientation, the template comprising a quadrilateral template bounding region having a side aligned with one of the two orthogonal axes and a set of template data values associated with the quadrilateral template bounding region, each template data value representing an intensity of reflected infrared light at a different location within a bounding area encompassing the patterned object;
(iii) computing a sum of the set of template data values;
(iv) acquiring input data values from the interactive display surface with the light sensor, each of the input data values corresponding to the intensity of infrared light reflected from a different one of the plurality of surface coordinate locations of the interactive display surface;
(v) calculating a difference score between the template data values and the input data values encompassed by the quadrilateral template bounding region; and;
(vi) if the difference score is within a match threshold, determining that the patterned object is adjacent to the interactive surface.

13. The system of claim 12, wherein the machine instructions further cause the processor to determine whether an integral sum of the input data values encompassed by the quadrilateral template bounding region is within a first threshold of the sum of the set of template data values, and if so continuing with calculating the difference score.

14. The system of claim 12, wherein:
(a) the template data values comprise pixel values, each pixel value indicating an intensity of infrared light reflected from the patterned object while the patterned object is adjacent to the interactive display surface in a template acquisition mode; and
(b) the input data values comprise pixel values indicating an intensity of light reflected from the patterned object while the patterned object is adjacent to the interactive display surface in a run-time mode.

15. The system of claim 14, wherein the machine instructions further cause the processor to:
(a) create a plurality of rotated templates, wherein each one of the plurality of rotated templates comprises a set of transformed template data values determined at a different rotation angle relative to the orthogonal axes;
(b) for each of the plurality of rotated templates, create a binary mask comprising:
(i) an active region having a shape and encompassing the set of transformed template data values, wherein an orientation of the active region matches an orientation of the rotated template relative to the orthogonal axes; and
(ii) a mask bounding region that is used for the quadrilateral template bounding region, the mask bounding region having a quadrilateral shape with a side aligned with one of the orthogonal axes and surrounding the active region, wherein an orientation of the mask bounding region remains fixed relative to the interactive display surface, and wherein dimensions of the mask bounding region are minimized to just encompass the active region;
(c) determine whether an integral sum of the input data values encompassed by the quadrilateral template bounding region is within a first threshold of the sum of the set of template data values by using the mask bounding region as the quadrilateral template bounding region so that a different rotated mask integral sum is computed for the input data values encompassed by each mask bounding region corresponding to each of the plurality of rotated templates, and so that the rotated mask integral sum is evaluated relative to the first threshold; and
(d) determine for which of the plurality of rotated templates the rotated mask integral sum of the rotated template most closely matches the sum of the set of template data values encompassed by the corresponding mask bounding region.

16. The system of claim 15, wherein the machine instructions further cause the processor to:
(a) create a list of rotated templates that are within the first threshold; and
(b) for each rotated template in the list, determine a distance between a first center associated with the mask bounding region corresponding to the rotated template and a second center associated with the mask bounding region used as the quadrilateral template bounding region;
(c) determine whether the distance is less than a redundancy threshold; and
(d) if the distance is less than the redundancy threshold, replace the rotated template in the list with the rotated template corresponding to the mask bounding region used as the quadrilateral template bounding region.

17. The system of claim 13, wherein to determine the integral sum, the machine language instructions further cause the processor to:
(a) compute an integral image array from the input data values, the integral image array comprising a plurality of array elements, each array element corresponding to one of the plurality of surface coordinate locations of the interactive display surface, and each array element comprising a sum of all input data values encompassed by a quadrilateral area from the surface origin to a corresponding surface coordinate location;
(b) select four array elements corresponding to four corners of the quadrilateral template bounding region, for association with a selected surface coordinate location and to align with the orthogonal axes; and
(c) compute the integral sum as a function of the four array elements, each of which represents an area encompassing input data values of the interactive display surface, thereby determining the sum of input data values encompassed by the quadrilateral template bounding region as a function of sums of quadrilateral areas between the surface origin and the quadrilateral template bounding region.

18. The system of claim 17, machine language instructions further cause the processor to associate the quadrilateral template bounding region with a succession of surface coordinate locations to determine an integral sum most closely matching the sum of the set of template data values, to detect a region of the interactive display surface to which the patterned object is adjacent.

19. The system of claim 18, wherein a plurality of integral sums are determined for a plurality of mask bounding regions corresponding to a plurality of rotated templates at each of the succession of surface coordinate locations.

20. The system of claim 12, wherein the difference score is calculated as one of a sum of absolute differences and a sum of squared differences.

21. The system of claim 12, machine language instructions further cause the processor to:
(a) compute a statistical moment of the set of template data values;
(b) compute a statistical moment of the input data values; and
(c) determine whether the statistical moment of the input data values is within a moment threshold percentage of the statistical moment of the set of template data values.

22. A method for detecting a patterned object placed adjacent to an interactive display surface, the interactive display surface having a diffusing surface for displaying images, a surface origin, and a plurality of surface coordinate locations defined along two orthogonal axes in relation to the surface origin, comprising the steps of:
(a) detecting reflected infrared light that has passed through the interactive display surface and been reflected from the patterned object back through the interactive display surface;
(b) comparing an image of the reflected infrared light to a plurality of template images to determine whether the patterned object corresponds to one of the plurality of template images associated with the patterned object; and
(c) if so, determining that the patterned object is adjacent to the interactive display surface.

23. The method of claim 22, wherein the image of the reflected infrared light comprises a range of intensities a plurality of discrete locations that can have more than two substantially different values for use in determining that the patterned object is adjacent to the interactive display surface.

24. The method of claim 23, wherein the range of intensities comprises a gray scale.

25. The method of claim 22, wherein the plurality of template images each corresponds to a different orientation of the patterned object relative to the orthogonal axes of the interactive display surface.

26. The method of claim 23, wherein the step of comparing comprises the steps of:
(a) determining a sum of the intensities in the image of the reflected infrared light from the patterned object;
(b) determining a sum of the intensities of infrared light for each of the plurality of template images; and
(c) comparing the sum of the intensities in the image of the reflected infrared light from the patterned object to each sum of the intensities of infrared light for each of the plurality of template images.
